(19) United States
(12) Patent Application Publication
(10) Pub. No.: US 2026/0127106 A1
(43) Pub. Date: May 7, 2026

(54) MEMORY SYSTEM AND OPERATING METHOD OF THE SAME

(71) Applicant: SK hynix Inc., Icheon-si (KR)

(72) Inventors: Duck Joo LEE, Icheon-si (KR); Dong Wook KIM, Icheon-si (KR); Min Cheol KWON, Icheon-si (KR); Dae Hoon JANG, Icheon-si (KR)

(21) Appl. No.: 19/097,279

(22) Filed: Apr. 1, 2025

(30) Foreign Application Priority Data
Nov. 5, 2024 (KR) 10-2024-0155084

(51) Int. Cl. G06F 12/02

(52) U.S. Cl. CPC G06F 12/0223

(57) ABSTRACT

A memory system includes: a memory device including a plurality of memory blocks, and a controller configured to manage the plurality of memory blocks as N block groups, wherein the controller comprises: N operation cores, each configured to manage access to a corresponding block group by mapping a corresponding one of N physical address ranges corresponding to the N block groups to a corresponding one of N first logical address ranges, and a control core configured to manage a second logical address range shared with a host by dividing the second logical address range into N third logical address ranges that are sequential, and to manage access to the N operation cores by dynamically mapping the N third logical address ranges to the N first logical address ranges.

### CROSS-REFERENCE TO RELATED APPLICATION

This application claims priority under 35 U.S.C. § 119(a) to Korean Patent Application No. 10-2024-0155084, filed in the Korean Intellectual Property Office on Nov. 5, 2024, the entire contents of which are incorporated herein by reference.

### BACKGROUND

### 1. Field

Exemplary embodiments relate to a memory system, and more particularly, to a memory system that efficiently supports a flexible data placement (FDP) function and an operating method of the memory system.

### 2. Discussion of the Related Art

Recently, a computer environment paradigm has shifted toward ubiquitous computing, which enables a computer system to be accessed anytime and everywhere. As a result, the use of portable electronic devices, such as mobile phones, digital cameras, notebook computers, and the like, has increased. Such portable electronic devices typically incorporate a memory system that includes at least one memory device as a data storage device. The data storage device may function as either a main storage device or an auxiliary storage device within the portable electronic device.

A Nonvolatile Memory Device Retains Stored Data Even When the power supply is interrupted. Representative examples of the nonvolatile memory device include a read only memory (ROM), a programmable ROM (PROM), an electrically programmable ROM (EPROM), an electrically erasable programmable ROM (EEPROM), a flash memory, a phase-change random access memory (PRAM), a magnetic RAM (MRAM), a resistive RAM (RRAM), a ferroelectric RAM (FRAM), etc.

In a computing device, a data storage device implemented as a nonvolatile semiconductor memory device offers several advantages over a hard disk. Unlike a hard disk, it has no mechanical driving part (e.g., a mechanical arm), resulting in enhanced stability and durability. Additionally, it provides high data access speed and low power consumption. Examples of such a data storage device include a universal serial bus (USB) memory device, a memory card having various interfaces, and a solid state drive (SSD).

A user of a memory system wants to efficiently and flexibly store as much data as needed through a flexible data placement (FDP) function, and to organize the data in a specific way. However, for the memory system to support the FDP function, the storage space of the memory system must be divided and managed across a plurality of cores. This division may result in an increase in the size of mapping information, which could lead to a rebuilding time when an error occurs.

### SUMMARY

Various embodiments are directed to a memory system that efficiently supports an FDP function through a multi-stage mapping operation and to an operating method of the memory system.

The problems addressed by the present disclosure are not limited to that mentioned above; additional unmentioned problems will be clearly understood by those skilled in the art from the following description.

An aspect of an embodiment in the disclosure, a memory system may include: a memory device including a plurality of memory blocks; and a controller configured to manage the plurality of memory blocks as N block groups, wherein the controller may include: N operation cores, each configured to manage access to a corresponding block group by mapping a corresponding one of N physical address ranges corresponding to the N block groups to a corresponding one of N first logical address ranges; and a control core configured to manage a second logical address range shared with a host by dividing the second logical address range into N third logical address ranges that are sequential, and to manage access to the N operation cores by dynamically mapping the N third logical address ranges to the N first logical address ranges, wherein N may be a natural number equal to or greater than 2.

An aspect of an embodiment in the disclosure, an operating method of a memory system, the memory system comprising a memory device including a plurality of memory blocks and a controller configured to manage the plurality of memory blocks as N block groups, wherein the controller includes a control core corresponding to a host and N operation cores respectively corresponding to the N block groups, the operating method may include: managing, by each of the N operation cores, access to a corresponding one of the N block groups using a corresponding one of N first mapping tables that stores mappings between a corresponding one of N physical address ranges corresponding to the N block groups and a corresponding one of N first logical address ranges; managing, by the control core, a second logical address range shared with a host by dividing the second logical address range into N third logical address ranges that are sequential; managing, by the control core, access to each of the N operation cores using a second mapping table that stores mappings between the N third logical address ranges and the N first logical address ranges, wherein the mappings are dynamically updated, wherein N may be a natural number equal to or greater than 2.

According to the present technology, after the control core, which manages an operation of a host, and the plurality of operation cores, which divide and control the plurality of storage spaces, are configured within the memory system, a logical mapping operation between the control core and the plurality of operation cores can be dynamically set.

Furthermore, at least one of a background operation or a journaling operation may be allowed for a corresponding storage space in each of the plurality of operation cores.

Accordingly, the size of mapping information can be adequately adjusted while effectively supporting the FDP function, and the rebuilding time can be prevented from increasing.

### BRIEF DESCRIPTION OF THE DRAWINGS

FIGS. 1A and 1B illustrate examples of a data processing system including a memory system according to embodiments of the present disclosure.

FIG. 2 illustrates the concept of a block group used in a memory system according to an embodiment of the present disclosure.

FIGS. 3A to 3C illustrate an operation for controlling a plurality of storage spaces through a multi-stage mapping operation in a memory system according to an embodiment of the present disclosure.

FIGS. 4A to 4C illustrate an operation for controlling a plurality of storage spaces through a multi-stage mapping operation in a memory system according to another embodiment of the present disclosure.

### DETAILED DESCRIPTION

Various embodiments of the present disclosure are described below with reference to the accompanying drawings. Elements and features of the disclosure, however, may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim do not foreclose the apparatus from including additional components (e.g., an interface unit, circuitry, etc.).

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational (e.g., is not turned on nor activated). The block/unit/circuit/component used with the “configured to” language includes hardware-for example, circuits, memory storing program instructions executable to implement the operation, etc. Additionally, “configured to” can include a generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that implement or perform one or more tasks.

As used in the disclosure, the term ‘circuitry’ or ‘logic’ refers to all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘circuitry’ or ‘logic’ applies to all uses of this term in this application, including in any claims. As a further example, as used in this application, the term “circuitry” or “logic” also covers an implementation of merely a processor (or multiple processors) or a portion of a processor and its (or their) accompanying software and/or firmware. The term “circuitry” or “logic” also covers, for example, and if applicable to a particular claim element, an integrated circuit for a storage device.

As used herein, the terms “first,” “second,” “third,” and so on are used as labels for nouns that the terms precede, and do not imply any type of ordering (e.g., spatial, temporal, logical, etc.). The terms “first” and “second” do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term “based on” is used to describe one or more factors that affect a determination. This term does not foreclose additional factors that may affect a determination. That is, a determination may be solely based on those factors or based, at least in part, on those factors. For example, the phrase “determine A based on B.” While in this case, B is a factor that affects the determination of A, such a phrase does not foreclose the determination of A from also being based on C. In other instances, A may be determined based solely on B.

Herein, an item of data, a data item, a data entry or an entry of data may be a sequence of bits. For example, the data item may include the contents of a file, a portion of the file, a page in memory, an object in an object-oriented program, a digital message, a digital scanned image, a part of a video or audio signal, metadata or any other entity which can be represented by a sequence of bits. According to an embodiment, the data item may include a discrete object. According to another embodiment, the data item may include a unit of information within a transmission packet between two different components.

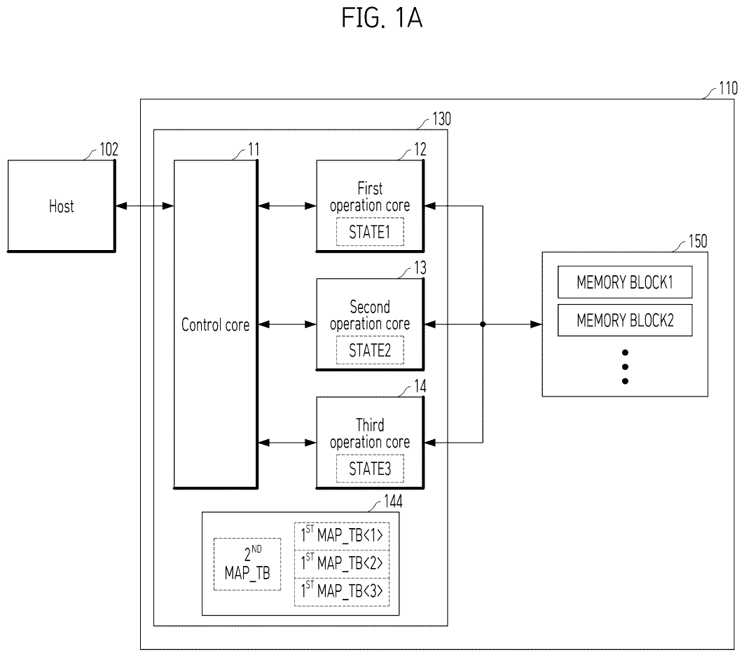

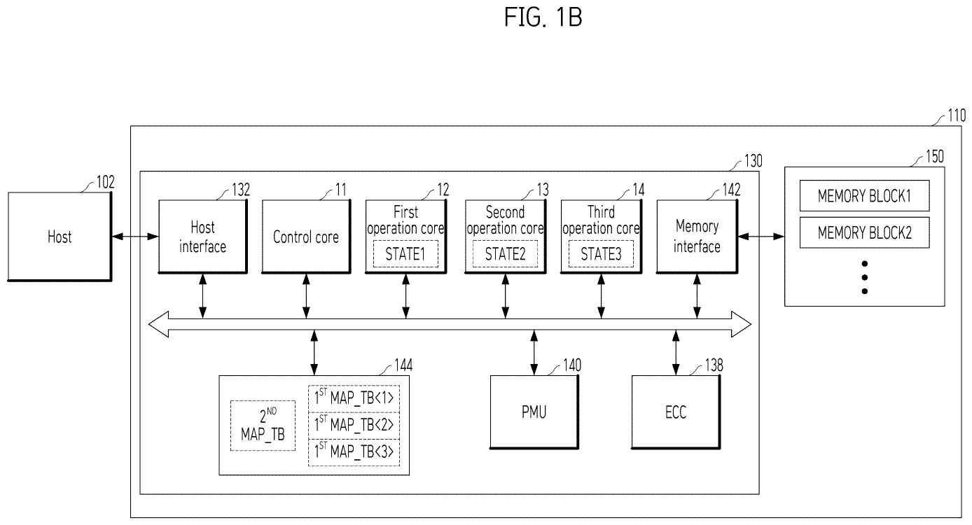

FIGS. 1A and 1B illustrate examples of a data processing system including a memory system according to embodiments of the present disclosure.

Referring to FIGS. 1A and 1B, the data processing system may include a host 102 and a memory system 110, the memory system 110 being engaged or coupled with the host 102. For example, the host 102 and the memory system 110 can be coupled to each other via a data bus, a host cable, and the like to perform data communication therebetween.

The memory system 110 may include a memory device 150 and a controller 130. The memory system 110 may store data under the control of the host 102, such as a mobile phone, a smartphone, an MP3 player, a laptop computer, a desktop computer, a game console, a TV, a tablet PC, or an in-vehicle infotainment system.

The memory device 150 and the controller 130 in the memory system 110 may be physically separated from each other. The memory device 150 and the controller 130 may be connected via at least one data path. For example, the data path may include a channel and/or a way.

According to an embodiment, the memory device 150 and the controller 130 may be functionally divided. Further, according to an embodiment, the memory device 150 and the controller 130 may be implemented with a single chip or a plurality of chips. The controller 130 may perform a data input/output operation in response to a request from an external device. For example, when the controller 130 performs a read operation in response to a read request from the external device, data stored in a plurality of non-volatile memory cells included in the memory device 150 is transferred to the controller 130.

The memory system 110 may be manufactured as any of various types of storage devices depending on a host interface that is a scheme for communication with the host 102. For example, the memory system 110 may be implemented as any of various types of storage devices, for example, a solid state drive (SSD), a multimedia card such as an MMC, an embedded MMC (eMMC), a reduced size MMC (RS-MMC), or a micro-MMC, a secure digital card such as an SD, a mini-SD, or a micro-SD, a universal serial bus (USB) storage device, a universal flash storage (UFS) device, a personal computer memory card international association (PCMCIA) card-type storage device, a peripheral component interconnection (PCI)-card type storage device, a PCI express (PCI-E) card-type storage device, a compact flash (CF) card, a smart media card, and a memory stick.

The memory system 110 may be manufactured in any of various types of package forms. For example, the memory system 110 may be manufactured in any of various types of package forms, such as package on package (POP), system in package (SIP), system on chip (SOC), multi-chip package (MCP), chip on board (COB), wafer-level fabricated package (WFP), and wafer-level stack package (WSP).

The memory device 150 may store data. The memory device 150 may operate under the control of the controller 130. The memory device 150 may include a memory cell array including a plurality of memory cells which store data.

The memory cell array may include a plurality of memory blocks MEMORY BLOCK<1, 2, . . . >. Each memory block may include a plurality of pages. Each page may include a plurality of memory cells.

Each memory block may be understood as a group of non-volatile memory cells from which data are removed together through an erase operation. Each memory block may include a page, in which non-volatile memory cells are logically grouped, such as for storing data together during a program operation or outputting data together during a read operation. For example, one memory block may include a plurality of pages, with each page including a plurality of non-volatile memory cells.

From a physical perspective, as opposed to a logical perspective (such as during the program operation or read operation), a memory block may be connected to a plurality of word lines. Each word line may be coupled to a plurality of non-volatile memory cells.

In this case, each word line may correspond to at least one page according to the number of bits that can be stored or expressed in one non-volatile memory cell. For example, when a non-volatile memory cell is a single level cell (SLC) storing one data bit, one word line may correspond to one page. When a non-volatile memory cell is a double level cell (DLC) storing two data bits, one word line may correspond to two pages. When a non-volatile memory cell is a triple level cell (TLC) storing three data bits, one word line may correspond to three pages. When a non-volatile memory cell is a quadruple level cell (QLC) storing four data bits, one word line may correspond to four pages. In this way, when a non-volatile memory cell is a multiple level cell storing five or more data bits, one word line may correspond to five or more pages.

In an embodiment, the memory device 150 may be implemented as a double data rate synchronous dynamic random access memory (DDR SDRAM), a low power double data rate fourth generation (LPDDR4) SDRAM, a graphics double data rate (DDDR) SDRAM, a low power DDR (LPDDR) SDRAM, a Rambus dynamic random access memory (RDRAM), a NAND flash memory, a vertical NAND flash memory, a NOR flash memory, a resistive RAM (RRAM), a phase-change RAM (PRAM), a magnetoresistive RAM (MRAM), a ferroelectric RAM (FRAM), or a spin transfer torque RAM (STT-RAM).

The memory device 150 may receive a command and an address from the controller 130, and may access an area of the memory cell array, selected by the address. The memory device 150 may perform an operation indicated by the command on the area selected by the address. For example, the memory device 150 may perform a write operation (i.e., a program operation), a read operation, and an erase operation. During a write operation, the memory device 150 may program data to the area selected by the address. During a read operation, the memory device 150 may read data from the area selected by the address. During an erase operation, the memory device 150 may erase data stored in the area selected by the address.

The controller 130 may control the overall operation of the memory system 110.

The controller 130 may control the memory device 150 to perform read, program, and erase operations in response to commands inputted from the host 102. In addition, the memory system 110 may independently perform these operations regardless of commands inputted from an external device such as the host 102.

When power is applied to the memory system 110, the controller 130 may run firmware (FW). When the memory device 150 is a flash memory device, the firmware (FW) may include a host interface layer (HIL) which controls communication with the host 102, a flash translation layer (FTL) which controls communication between the host 102 and the memory device 150, and a flash interface layer (FIL) which controls communication with the memory device 150.

In an embodiment, the controller 130 may receive data and a logical block address (LBA) from the host 102, and may translate the logical block address (LBA) into a physical block address (PBA) indicating memory cells which are included in the memory device 150 and in which data is to be stored. In the present specification, the terms “logical block address (LBA)” and “logical address” may be used interchangeably. In the present specification, the terms “physical block address (PBA)” and “physical address” may be used interchangeably.

The controller 130 may control the memory device 150 so that a write operation, a read operation, or an erase operation is performed in response to a request received from the host 102. During a write operation, the controller 130 may provide a write command, a physical block address, and data to the memory device 150. During a read operation, the controller 130 may provide a read command and a physical block address to the memory device 150. During an erase operation, the controller 130 may provide an erase command and a physical block address to the memory device 150.

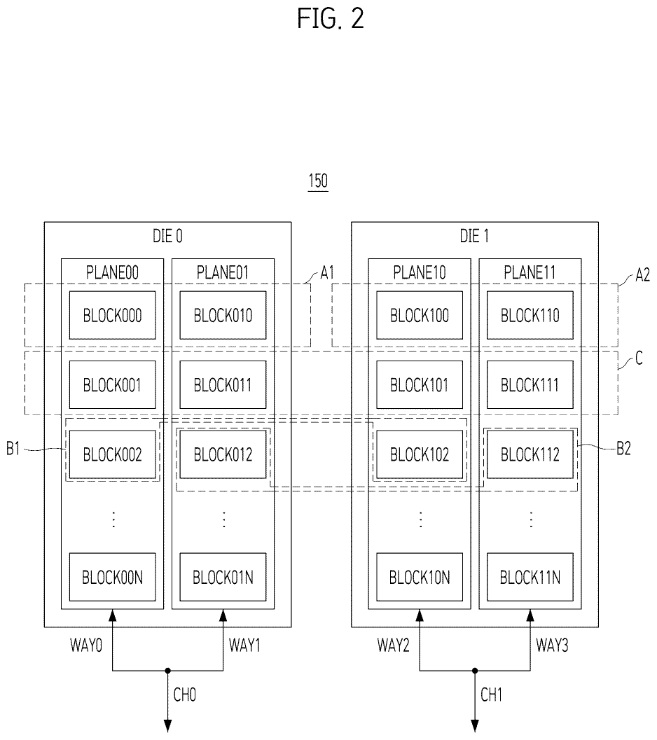

Specifically, the controller 130 may manage the plurality of memory blocks MEMORY BLOCK<1, 2, . . . > included in the memory device 150 in the form of N block groups. In this case, N may be a natural number equal to or greater than 2. For reference, for a relation between the plurality of memory blocks MEMORY BLOCK<1, 2, . . . > and the N block groups, reference may be made to the description given with reference to FIG. 2.

The controller 130 may include a control core 11, N operation cores, e.g., three operation cores 12, 13, and 14 when N is 3, and internal memory 144.

In this case, the N operation cores may control access to the N block groups, respectively, by mapping N physical address ranges, which respectively correspond to the N block groups, to N first logical address ranges, respectively.

Furthermore, the control core 11 may manage a second logical address range that is shared with the host 102 by dividing the second logical address range into N third logical address ranges that are sequential, and may manage access to each of the N operation cores by dynamically mapping the N third logical address ranges to the N first logical address ranges, respectively.

Furthermore, the controller 130 may store, in the internal memory 144, N first mapping tables, e.g., three first mapping tables 1^{ST} MAP_TB<1:3> corresponding to the operation cores 12, 13, and 14, respectively, and a second mapping table 2^{ND} MAP_TB corresponding to the control core 11.

More specifically, each of the N operation cores may manage any one corresponding physical address range, among the N physical address ranges, and any one corresponding first logical address range, among the N first logical address ranges, in any one corresponding first mapping table, among the N first mapping tables, by mapping the corresponding physical address range and the corresponding first logical address range.

For example, the first operation core 12 may manage the first physical address range, which indicates the first block group, and the first logical address range in the first mapping table 1^{ST} MAP_TB<1>, by mapping the first physical address range and the first logical address range.

Similarly, the second operation core 13 may manage the second physical address range, which indicates the second block group, and the second logical address range in the second mapping table 1^{ST} MAP_TB<2>, by mapping the second physical address range and the second logical address range.

Likewise, the third operation core 14 may manage the third physical address range, which indicates the third block group, and the third logical address range in the third mapping table 1^{ST} MAP_TB<3>, by mapping the third physical address range and the third logical address range.

As shown in FIG. 1A, the first mapping tables 1^{ST} MAP_TB<1:3>, corresponding to the operation cores 12, 13, and 14, respectively, may be managed independently.

According to an embodiment, each of the operation cores 12, 13, and 14 may control a background operation within any one corresponding block group, among the three block groups, with reference to any one corresponding first mapping table among the three first mapping tables 1^{ST} MAP_TB<1:3>.

According to another embodiment, each of the operation cores 12, 13, and 14 may generate journal data in units of a corresponding block group among the three block groups, with reference to a corresponding first mapping table among the three first mapping tables 1^{ST} MAP_TB<1:3>, and may perform a journaling operation that includes a journal replay operation.

Furthermore, the operation cores 12, 13, and 14 may each generate pieces of state information STATE<1:3> by accumulating operation states of the respective block groups.

According to an embodiment, each of the operation cores 12, 13, and 14 may generate each of the pieces of the state information STATE<1:3> by accumulating an error rate occurring after the start of an access operation for its respective block group as an operation state of the block group.

According to another embodiment, each of the operation cores 12, 13, and 14 may generate each of the pieces of state information STATE<1:3> by accumulating the types and number of background operations that are performed in its respective block group as an operation state of the block group.

Furthermore, the control core 11 may check the pieces of state information STATE<1:3> at each set cycle, and may manage the three third logical address ranges and the three first logical address ranges in the second mapping table 2^{ND} MAP_TB. Specifically, the control core 11 may dynamically map the three third logical address ranges to the three first logical address ranges, respectively, based on the check results.

In this case, the operation performed by the control core 11 to map the three third logical address ranges to the three first logical address ranges, respectively, may involve dividing first write data, which are received from the host 102 after the start of a write operation and correspond to a second logical address range, into three second write data, each corresponding to one of the three third logical address ranges. The control core 11 may then transmit the three second write data to the operation cores 12, 13, and 14, which correspond to the three first logical address ranges mapped to the respective third logical address ranges.

Likewise, the mapping operation performed by the control core 11 may involve generating second read data corresponding to the second logical address range. This is done by combining three first read data, which are transmitted from the three block groups via the N operation cores 12, 13, and 14, respectively, based on the mapping of the three third logical address ranges to the three first logical address ranges, respectively, after the start of a read operation. The control core 11 may then output the generated second read data to the host 102.

Furthermore, the control core 11 may dynamically adjust the mapping of the three third logical address ranges to the three first logical address ranges in a second operation interval, after a set cycle has elapsed following a first operation interval.

Specifically, in the first operation interval, the control core 11 may manage access to the first operation core 12 by mapping the first-third logical address range, among the three third logical address ranges, to the first-first logical address range, among the three first logical address ranges, manage access to the second operation core 13 by mapping the second-third logical address range to the second-first logical address range, and manage access to the third operation core 14 by mapping the third-third logical address range to the third-first logical address range.

Furthermore, after the set cycle has elapsed following the first operation interval, the control core 11 may check the pieces of state information STATE<1:3>. Based on the check results, in the subsequent second operation interval, the control core 11 may manage access to the second operation core 13 by mapping the first-third logical address range to the second-first logical address range, manage access to the third operation core 14 by mapping the second-third logical address range to the third-first logical address range, and manage access to the first operation core 12 by mapping the third-third logical address range to the first-first logical address range.

As described above, the control core 11 may check the pieces of state information STATE<1:3> at each set cycle, and may dynamically adjust the mapping of the three first logical address ranges mapped to the three third logical address ranges based on the check results. The adjusted mapping information may be managed in the second mapping table 2^{ND} MAP_TB.

Comparing FIGS. 1A and 1B, the controller 130 and the memory device 150 illustrated in FIG. 1A may correspond to components of the memory system 110 illustrated in FIG. 1B. Specifically, the controller 130 illustrated in FIG. 1A may represent some of the components included in the controller 130 of the memory system 110 illustrated in FIG. 1B. Accordingly, the components labelled with reference numerals 11, 12, 13, 14, and 144 in FIG. 1A are also present in FIG. 1B.

Specifically, in FIG. 1B, the controller 130 may include a host interface 132, a power management unit (PMU) 140, a memory interface 142, and an error correction unit (error correction code (ECC)) 138, along with the operation cores 12, 13, and 14, the control core 11, and the internal memory 144.

Each of the host 102 and the memory system 110 may include a controller or an interface for transmitting and receiving signals, data, and the like according to one or more predetermined protocols. For example, the host interface 132 in the memory system 110 may include an apparatus capable of transmitting signals, data, and the like to the host 102 or receiving signals, data, and the like from the host 102.

The host interface 132 included in the controller 130 may receive signals, commands (or requests), and/or data from the host 102 via a bus. For example, the host 102 and the memory system 110 may communicate using a predefined protocol or interface for data transmission and reception.

Examples of communication standards or interfaces for data transmission and reception may include various form factors, such as 2.5-inch form factor, 1.8-inch form factor, MO-297, MO-300, M.2, and EDSFF (Enterprise and Data Center SSD Form Factor). Supported communication standards or interfaces may include USB (Universal Serial Bus), MMC (Multi-Media Card), PATA (Parallel Advanced Technology Attachment), SCSI (Small Computer System Interface), ESDI (Enhanced Small Disk Interface), IDE (Integrated Drive Electronics), PCIe (Peripheral Component Interconnect Express), SAS (Serial-attached SCSI), SATA (Serial Advanced Technology Attachment), and MIPI (Mobile Industry Processor Interface).

According to an embodiment, the host interface 132 serves as a layer for exchanging data with the host 102 and is driven by firmware called a host interface layer (HIL). According to an embodiment, the host interface 132 may include a command queue.

The Integrated Drive Electronics (IDE) or Advanced Technology Attachment (ATA) may be used as one of the interfaces for data transmission and reception. For example, it may use a cable including 40 wires connected in parallel to support data transmission and reception between the host 102 and the memory system 110. When a plurality of memory systems 110 are connected to a single host 102, the plurality of memory systems 110 may be divided into a master and a slave configuration using a position or a DIP switch. The memory system 110 set as the master may function as a main memory device. The IDE (ATA) may include Fast-ATA, ATAPI, or Enhanced IDE (EIDE).

A Serial Advanced Technology Attachment (SATA) interface is a type of serial data communication interface that is compatible with various ATA standards of parallel data communication interfaces which are used by Integrated Drive Electronics (IDE) devices. The 40 wires in the IDE interface can be reduced to six wires in the SATA interface. For example, 40 parallel signals for the IDE can be converted into 6 serial signals for the SATA interface. The SATA interface has been widely used because of its faster data transmission and reception rate and its less resource consumption in the host 102 used for the data transmission and reception. The SATA interface may connect up to 30 external devices to a single transceiver included in the host 102. In addition, the SATA interface can support hot plugging that allows an external device to be attached to or detached from the host 102, even while data communication between the host 102 and another device is being executed. Thus, the memory system 110 can be connected or disconnected as an additional device, like a device supported by a universal serial bus (USB) even when the host 102 is powered on. For example, in the host 102 having an eSATA port, the memory system 110 may be freely attached to or detached from the host 102 like an external hard disk.

Small Computer System Interface (SCSI) is a type of serial data communication interface used for connecting a computer or a server with other peripheral devices. The SCSI can provide a high transmission speed, as compared with other interfaces such as IDE and SATA. In the SCSI, the host 102 and at least one peripheral device (e.g., memory system 110) are connected in series, but data transmission and reception between the host 102 and each peripheral device may be performed through a parallel data communication. In the SCSI, it is easy to connect or disconnect a device such as the memory system 110 to or from the host 102. The SCSI can support connections of 15 other devices to a single transceiver included in host 102.

Serial Attached SCSI (SAS) can be understood as a serial data communication version of the SCSI. In the SAS, the host 102 and a plurality of peripheral devices are connected in series, and data transmission and reception between the host 102 and each peripheral device may be performed in a serial data communication scheme. The SAS can support connection between the host 102 and the peripheral device through a serial cable instead of a parallel cable, to easily manage equipment using the SAS and enhance or improve operational reliability and communication performance. The SAS may support connections of eight external devices to a single transceiver included in the host 102.

The Non-volatile memory express (NVMe) is a type of interface based at least on a Peripheral Component Interconnect Express (PCIe) designed to increase performance and design flexibility of the host 102, servers, computing devices, and the like equipped with the non-volatile memory system 110. The PCIe can use a slot or a specific cable for connecting a computing device (e.g., host 102) and a peripheral device (e.g., memory system 110). For example, the PCIe can use a plurality of pins (e.g., 18 pins, 32 pins, 49 pins, or 82 pins) and at least one wire (e.g., x1, x4, x8, or x16) to achieve high speed data communication over several hundred MB per second (e.g., 250 MB/s, 500 MB/s, 984.6250 MB/s, or 1969 MB/s). According to an embodiment, the PCIe scheme may achieve bandwidths of tens to hundreds of Giga bits per second. The NVMe can support an operation speed of the non-volatile memory system 110, such as an SSD, that is faster than a hard disk.

According to an embodiment, the host 102 and the memory system 110 may be connected through a universal serial bus (USB). The Universal Serial Bus (USB) is a type of scalable, hot-pluggable plug-and-play serial interface that can provide cost-effective standard connectivity between the host 102 and peripheral devices such as a keyboard, a mouse, a joystick, a printer, a scanner, a storage device, a modem, a video camera, and the like. A plurality of peripheral devices such as the memory system 110 may be coupled to a single transceiver included in the host 102.

The power management unit (PMU) 140 may control electrical power provided to the controller 130. The PMU 140 may monitor the electrical power supplied to the memory system 110, e.g., a voltage supplied to the controller 130, and provide the electrical power to components included in the controller 130. The PMU 140 may not only detect power-on or power-off, but also generate a trigger signal to enable the memory system 110 to urgently back up a current state when the electrical power supplied to the memory system 110 is unstable. According to an embodiment, the PMU 140 may include a device or a component capable of accumulating electrical power that may be used in an emergency.

The memory interface 142 may serve as an interface for handling commands and data transferred between the controller 130 and the memory device 150, in order to allow the controller 130 to control the memory device 150 in response to a command or a request input from the host 102. The memory interface 142 may generate a control signal for the memory device 150 and may process data input to, or output from, the memory device 150 under the control of the processor 134 in a case when the memory device 150 is a flash memory.

For example, when the memory device 150 includes a NAND flash memory, the memory interface 142 includes a NAND flash controller (NFC). The memory interface 142 can provide an interface for handling transmission of commands and data between the controller 130 and the memory device 150. In accordance with an embodiment, the memory interface 142 can be driven by firmware called a Flash Interface Layer (FIL) for exchanging data with the memory device 150.

According to an embodiment, the memory interface 142 may support an open NAND flash interface (ONFi), a toggle mode, or the like, for data input/output with the memory device 150. For example, the ONFi may use a data path (e.g., a channel, a way, etc.) that includes at least one signal line capable of supporting bi-directional transmission and reception in a unit of 8-bit or 16-bit data. Data communication between the controller 130 and the memory device 150 can be achieved through at least one interface regarding an asynchronous single data rate (SDR), a synchronous double data rate (DDR), a toggle double data rate (DDR), or the like.

The internal memory 144 that is included in the controller 130 as operation memory may store data for operations of the memory system 110 and the controller 130. More specifically, the internal memory 144 may store data necessary for control when the controller 130 controls the memory device 150 in response to a request from the host 102.

The control core 11 and the operation cores 12, 13, and 14 control an overall operation of the memory system 110. In particular, the control core 11 and the operation cores 12, 13, and 14 may control a write operation or a read operation for the memory device 150 in response to a write request or read request from the host 102.

According to an embodiment, the control core 11 and the operation cores 12, 13, and 14 may execute firmware to control the program operation or the read operation in the memory system 110. Herein, the firmware may be referred to as a flash translation layer (FTL). According to an embodiment, the control core 11 and the operation cores 12, 13, and 14 may be implemented using a microprocessor, a central processing unit (CPU), or similar components.

Furthermore, each of the control core 11 and the N operation cores 12, 13, and 14 may be implemented with a microphone processor or a central processing unit (CPU). Although the control core 11 and the operation cores 12, 13, and 14 are shown as physically separate for convenience, they may actually consist of a plurality of internal cores physically implemented within a single processor or software architecture.

For reference, if the control core 11 and the operation cores 12, 13, and 14 are implemented in software, the control core 11 and the N operation cores 12, 13, and 14 may be referred to as “threads” or “modules” instead of “cores,” which typically refer to physical operation devices. For example, the “control core 11 and the operation cores 12, 13, and 14” may be substituted with “control thread and operation threads” or “control module and operation modules. ” The terms are merely a substitution, and operations performed by the “control thread and operation threads” or the “control module and operation modules” may be substantially the same as those of the control core 11 and the operation cores 12, 13, and 14.

For instance, the controller 130 performs an operation requested by the host 102 in the memory device 150. Specifically, the controller 130 performs a command operation corresponding to a command received from the host 102, utilizing the control core 11 and the operation cores 12, 13, and 14. The controller 130 may perform the command operation as a foreground operation. For example, as the command operation, the controller 130 may perform a program operation corresponding to a write command, a read operation corresponding to a read command, an erase operation corresponding to an erase command.

The controller 130 may also perform a background operation for the memory device 150 using the control core 11 and the operation cores 12, 13, and 14. The background operation for the memory device 150 may include an operation of copying data from one memory block to another memory block, for example, a garbage collection (GC) operation. The background operation may also include an operation of swapping data between memory blocks in the memory device 150, for example, a wear leveling (WL) operation, a read reclaim (RR) operation, and a media scan operation. The background operation may also include an operation of storing map data retrieved from the controller 130 into the memory blocks in the memory device 150, for example, a map flush operation. Additionally, the background operation may include a bad block management operation for the memory device 150, which may include checking for and processing any bad blocks among the memory blocks in the memory device 150. Thus, the types of background operations may include garbage collection (GC), read reclaim (RR), wear leveling (WL), map flush, and bad block management operations.

Furthermore, the controller 130 may perform a journaling operation on the memory device 150 through the control core 11 and the operation cores 12, 13, and 14. In this case, the journaling operation ensures the consistency and integrity of data stored in the memory device 150 and may include a journal data generation operation and a journal replay operation.

For reference, in FIG. 1B, the three operation cores 12, 13, and 14 are shown as part of the controller 130, assuming that N is 3. However, this is just one embodiment, and the controller 130 may include either fewer or more than three operation cores.

FIG. 2 illustrates the concept of a block group used in the memory system 150 according to an embodiment of the present disclosure.

Referring to FIG. 2, the memory device 150 includes a plurality of memory blocks BLOCK 000 to BLOCK 11N The memory device 150 may include a plurality of dies, such as a zeroth memory die DIE0 and a first memory die DIE1. The zeroth memory die DIE0 is configured to input and output data through a zeroth channel CH0. The first memory die DIE1 is configured to input and output data through a first channel CH1. The zeroth channel CH0 and the first channel CH1 may input and output data in an interleaving manner.

The zeroth memory die DIE0 may include a plurality of planes, such as PLANE00 and PLANE01, which are configured to input and output data in the interleaving manner by sharing the zeroth channel CH0 through corresponding zeroth and first ways WAY0 and WAY1.

The first memory die DIE1 may include a plurality of planes, such as PLANE10 and PLANE11, which are configured to input and output data in the interleaving manner by sharing the first channel CH1 through corresponding second and third WAY2 and WAY3.

The first plane PLANE00 of the zeroth memory die DIE0 may include the memory blocks BLOCK 000 to BLOCK 00N among the plurality of memory blocks BLOCK 000 to BLOCK 11N.

The second plane PLANE01 of the zeroth memory die DIE0 may include the memory blocks BLOCK 010 to BLOCK 01N among the plurality of memory blocks BLOCK 000 to BLOCK 11N.

The first plane PLANE10 of the first memory die DIE1 may include the memory blocks BLOCK 100 to BLOCK 10N among the plurality of memory blocks BLOCK 000 to BLOCK 11N.

The second plane PLANE11 of the first memory die DIE1 may include the memory blocks BLOCK 110 to BLOCK 11N among the plurality of memory blocks BLOCK 000 to BLOCK 11N.

Hence, the plurality of memory blocks BLOCK 000 to BLOCK 11N included in the memory device 150 may be grouped based on their physical locations and their utilization of the ways and channels.

FIG. 2 illustrates an example where the memory device 150 includes two memory dies DIE0 and DIE1, with each die including two planes and each plane including the same predetermined number of memory blocks. It is noted that, depending on the designer's choice, the number of memory dies included in the memory device 150 may be greater or smaller than two, and each memory die may include a greater or smaller number of planes. Additionally, the number of memory blocks included in each plane may be adjusted as needed based on the designer's specifications.

The controller 130 may manage the plurality of memory blocks BLOCK 000 to BLOCK 11N in the memory device 150 by grouping at least some of the memory blocks BLOCK 000 to BLOCK 11N into one or more super memory blocks, such as A1, A2, B1, B2, or C in FIG. 2. The controller 130 may select memory blocks within each super memory block simultaneously.

In the respective super memory blocks, memory blocks may be simultaneously selected using an interleaving scheme, such as a channel interleaving scheme, a memory die interleaving scheme, a memory chip interleaving scheme, or a way interleaving scheme.

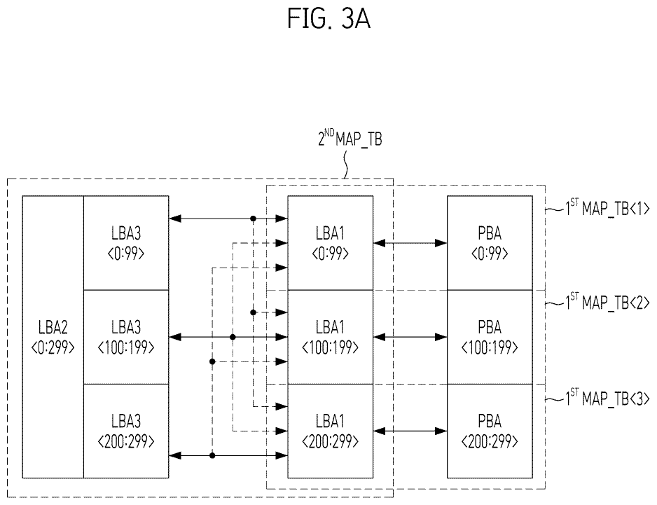

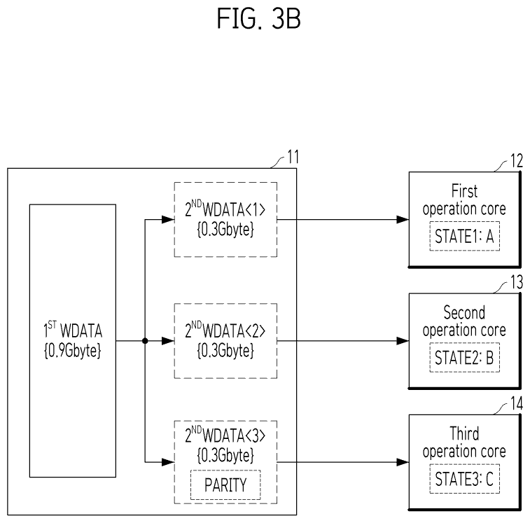

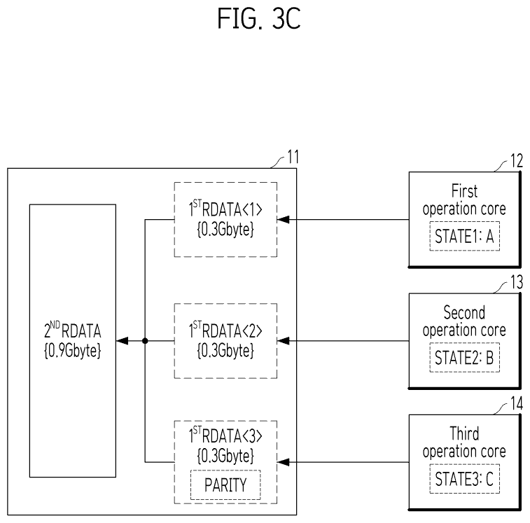

FIGS. 3A to 3C illustrate an operation for controlling a plurality of storage spaces through a multi-stage mapping operation in the memory system 110 according to an embodiment of the present disclosure.

First, as assumed and exemplified in FIGS. 1A and 1B, N is assumed to be 3 for illustrative purposes. This example is provided for convenience of description, and the actual value of N may be set to a smaller or greater number as needed.

Referring to FIG. 3A, the controller 130 in the memory system 110, according to an embodiment of the present disclosure, performs a staged operation. The stage operation includes mapping a logical address LBA1 corresponding to the first to third operation cores 12, 13, and 14 to a physical address PBA corresponding to the first to third block groups using three first mapping tables 1^{ST} MAP_TB<1:3>. Additionally, the stage operation includes mapping a logical address LBA2 corresponding to the control core 11 and the logical address LBA1 corresponding to the first to third operation cores 12, 13, and 14 using a second mapping table 2^{ND} MAP_TB.

Specifically, the first to third operation cores 12, 13, and 14 included in the controller 130 may divide the plurality of memory blocks MEMORY BLOCK<1, 2, . . . > included in the memory device 150 into the first to third block groups, and may manage the mapping operations of mapping three first logical address ranges LBA1<0:99>, LBA1<100:199>, and LBA1<200:299>, which correspond to the first to third operation cores 12, 13, and 14, to three physical address ranges PBA<0:99>, PBA<100:199>, and PBA<200:299>, which correspond to the first to third block groups, using the three first mapping tables 1^{ST} MAP_TB<1:3>.

For example, the first block group may correspond to the Nos. 0 to 99 physical address ranges PBA<0:99>. The second block group may correspond to the Nos. 100 to 199 physical address ranges PBA<100:199>. The third block group may correspond to the Nos. 200 to 299 physical address ranges PBA<200:299>. Furthermore, the first operation core 12 may correspond to the Nos. 0 to 99 first logical address ranges LBA1<0:99>. The second operation core 13 may correspond to the Nos. 100 to 199 first logical address ranges LBA1<100:199>. The third operation core 14 may correspond to the Nos. 200 to 299 first logical address ranges LBA1<200:199>.

In this state, the first operation core 12 may control an access operation for the first block group by managing a mapping operation between the Nos. 0 to 99 first logical address ranges LBA1<0:99> and the Nos. 0 to 99 physical address ranges PBA<0:99> using the first mapping table 1^{ST} MAP_TB<1> from among the three first mapping tables 1^{ST} MAP_TB<1:3>.

Furthermore, the second operation core 13 may control an access operation for the second block group by managing a mapping operation between the Nos. 100 to 199 first logical address ranges LBA1<100:199> and the Nos. 100 to 199 physical address ranges PBA<100:199> using the second mapping table 1^{ST} MAP_TB<2> from among the three first mapping tables 1^{ST} MAP_TB<1:3>.

Furthermore, the third operation core 14 may control an access operation for the third block group by managing a mapping operation between the Nos. 200 to 299 first logical address ranges LBA1<200:299> and the Nos. 200 to 299 physical address ranges PBA<200:299> using the third mapping table 1^{ST} (1^{ST} MAP_TB<3> from among the three first mapping tables 1^{ST} MAP_TB<1:3>.

As described above, the first to third operation cores 12, 13, and 14 may independently control access operations for the first to third block groups using the three first mapping tables 1^{ST} MAP_TB<1:3>.

According to an embodiment, the first to third operation cores 12, 13, and 14 may independently control background operations for the first to third block groups using the three first mapping tables 1^{ST} MAP_TB<1:3>. In this case, executing a background operation in any block group may involve copying or swapping data between a plurality of memory blocks within that block group, regardless of a request from the host 102.

According to another embodiment, the first to third operation cores 12, 13, and 14 may each generate journal data at the block group level for the first to third block groups using the three first mapping tables 1^{ST} MAP_TB<1:3>. Each core may also perform a journaling operation, including a journal replay operation.

Furthermore, the control core 11 included in the controller 130 may divide the second logical address ranges LBA2<0:299> shared with the host 102 within the second mapping table 2^{ND} MAP_TB into three sequential third logical address ranges LBA3<0:99>, LBA3<100:199>, and LBA3<200:299>. The control core 11 may then manage mapping operations between the three third logical address ranges LBA3<0:99>, LBA3<100:199>, and LBA3<200:299> and the three first logical address ranges LBA1<0:99>, LBA1<100:199>, and LBA1<200:299> corresponding to the first to third operation cores 12, 13, and 14, respectively.

For example, the control core 11 may divide the first 100 sequential second logical address ranges from the total 300 second logical address ranges LBA2<0:299> shared with the host 102 within the second mapping table 2^{ND} MAP_TB into the Nos. 0 to 99 third logical address ranges LBA3<0:99>. It may divide the second 100 sequential second logical address ranges into the Nos. 100 to 199 third logical address ranges LBA3<100:199>, and divide the third 100 sequential second logical address ranges into the Nos. 200 to 299 third logical address ranges LBA3<200:299>.

In this state, the control core 11 may control an access operation for the first operation core 12 by managing a mapping operation between the Nos. 0 to 99 third logical address ranges LBA3<0:99> and the Nos. 0 to 99 first logical address ranges LBA1<0:99> within the second mapping table 2^{ND} MAP_TB. In this case, the first operation core 12 can control an access operation for the first block group using the first-first mapping table 1^{ST} MAP_TB<1>, from among the three first mapping tables 1^{ST} MAP_TB<1:3>. Accordingly, the control of the access operation for the first operation core 12 by the control core 11 may mean that the access operation for the first block group is controlled.

Furthermore, the control core 11 may control an access operation for the second operation core 13 by managing a mapping operation between the Nos. 100 to 199 third logical address ranges LBA3<100:199> and the Nos. 100 to 199 first logical address ranges LBA1<100:199> within the second mapping table 2^{ND} MAP_TB. In this case, the second operation core 13 can control an access operation for the second block group using the second-first mapping table 1^{ST} MAP_TB<2>, from among the three first mapping tables 1^{ST} MAP_TB<1:3>. Accordingly, the control of the access operation for the second operation core 13 by the control core 11 may mean that the access operation for the second block group is controlled.

Furthermore, the control core 11 may control an access operation for the third operation core 14 by managing a mapping operation between the Nos. 200 to 299 third logical address ranges LBA3<200:299> and the Nos. 200 to 299 first logical address ranges LBA1<200:299> within the second mapping table 2^{ND} MAP_TB. In this case, the third operation core 14 may control an access operation for the third block group using the third-first mapping table 1^{ST} MAP_TB<3>, from among the three first mapping tables 1^{ST} MAP_TB<1:3>. Accordingly, the control of the access operation for the third operation core 14 by the control core 11 may mean that the access operation for the third block group is controlled.

Referring to the three first mapping tables 1^{ST} MAP_TB<1:3> and the second mapping table 2^{ND} MAP_TB described with reference to FIG. 3A, a write (or program) operation may be performed as illustrated in FIG. 3B.

Specifically, referring to FIGS. 3A and 3B, first write data 1^{ST} WDATA may be input from the host 102. In this case, it may be assumed that the size of the first write data 1^{ST} WDATA is 0.9 Gbyte.

The control core 11 may divide the second logical address ranges LBA2<0:299> corresponding to the first write data 1^{ST} WDATA into the three third logical address ranges LBA3<0:99>, LBA3<100:199>, and LBA3<200:299>, and thus divide the first write data 1^{ST} WDATA into three second write data 2^{ND} WDATA<1:3>. In this case, the size of each of the three second write data 2^{ND} WDATA<1:3> may be 0.3 Gbyte because the size of the first write data 1^{ST} WDATA is 0.9 Gbyte.

The control core 11 may transmit the three second write data 2^{ND} WDATA<1:3> to the first to third operation cores 12, 13, and 14, respectively, based on the state in which the three third logical address ranges LBA3<0:99>, LBA3<100:199>, and LBA3<200:299> have been mapped to the three first logical address ranges LBA1<0:99>, LBA1<100:199>, and LBA1<200:299>, respectively, within the second mapping table 2^{ND} MAP_TB.

The first to third operation cores 12, 13, and 14 may write the three second write data 2^{ND} WDATA<1:3> into the first to third block groups, respectively, based on the state in which the three first logical address ranges LBA1<0:99>, LBA1<100:199>, and LBA1<200:299> have been mapped to the three physical address ranges PBA<0:99>, PBA<100:199>, and PBA<200:299> in the three first mapping tables 1^{ST} MAP_TB<1:3>, respectively.

For example, the control core 11 may transmit the first-second write data 2^{ND} WDATA<1>, from among the three second write data 2^{ND} WDATA<1:3>, to the first operation core 12. Accordingly, the first operation core 12 may write the first-second write data 2^{ND} WDATA<1>, from among the second write data 2^{ND} WDATA<1:3>, into the first block group.

Similarly, the control core 11 may transmit the second-second write data 2^{ND} WDATA<2>, from among the three second write data 2^{ND} WDATA<1:3>, to the second operation core 13. Accordingly, the second operation core 12 may write the second-second write data 2^{ND} WDATA<2>, from among the second write data 2^{ND} WDATA<1:3>, into the second block group.

Likewise, the control core 11 may transmit the third-second write data 2^{ND} WDATA<3>, from among the three second write data 2^{ND} WDATA<1:3>, to the third operation core 14. Accordingly, the third operation core 13 may write the third-second write data 2^{ND} WDATA<3>, from among the second write data 2^{ND} WDATA<1:3>, into the third block group.

Furthermore, referring to the three first mapping tables 1^{ST} MAP_TB<1:3> and the second mapping table 2^{ND} MAP_TB described with reference to FIG. 3A, a read operation may be performed as illustrated in FIG. 3C.

Specifically, referring to FIGS. 3A and 3C, the first to third operation cores 12, 13, and 14 may read three first read data 1^{ST} RDATA<1:3> from the first to third block groups, respectively, based on the state in which the three first logical address ranges LBA1<0:99>, LBA1<100:199>, and LBA1<200:299> have been mapped to the three physical address ranges PBA<0:99>, PBA<100:199>, and PBA<200:299>, respectively, in the three first mapping tables 1^{ST} MAP_TB<1:3>, respectively. In this case, the size of each of the three first read data 1^{ST} RDATA<1:3> may be 0.3 Gbyte.

The control core 11 may output the three first read data 1^{ST} RDATA<1:3> as one second read data 2^{ND} RDATA, based on the state where the three third logical address ranges LBA3<0:99>, LBA3<100:199>, and LBA3<200:299> have been mapped to the three first logical address ranges LBA1<0:99>, LBA1<100:199>, and LBA1<200:299>, respectively, within the second mapping table 2^{ND} MAP_TB and where the three third logical address ranges LBA3<0:99>, LBA3<100:199>, and LBA3<200:299> are sequentially merged as one second logical address ranges LBA2<0:299>. In this case, the size of each of the second read data 2^{ND} RDATA may be 0.9 Gbyte because the size of each of the three first read data 1^{ST} RDATA<1:3> is 0.3 Gbyte. After that, the control core 11 may output the second read data 2^{ND} RDATA having the size of 0.9 Gbyte to the host 102.

The first to third operation cores 12, 13, and 14 may generate corresponding first to third state information STATE<1:3> by accumulating the operation state of the respective first to third block groups. That is, the first operation core 12 may generate the first state information STATE1 by accumulating the operation state of the first block group. Similarly, the second operation core 13 may generate the second state information STATE2 by accumulating the operation state of the second block group. Likewise, the third operation core 14 may generate the third state information STATE3 by accumulating the operation state of the third block group.

According to an embodiment, the first to third operation cores 12, 13, and 14 may generate the first to third state information STATE<1:3> by accumulating an error rate that occurs after the start of an access operation for the respective first to third block groups as part of their operation state.

For example, when an error rate occurring after the start of an access operation for the first block group is at or below a first reference value, the first operation core 12 may generate the first state information STATE1 having a value A. Similarly, when an error rate occurring after the start of an access operation for the second block group is at or below a second reference value, which is greater than the first reference value, the second operation core 13 may generate the second state information STATE2 having a value B. Likewise, when an error rate occurring after the start of an access operation for the third block group is at or below a third reference value, which is greater than the second reference value, the third operation core 14 may generate the third state information STATE3 having a value C.

According to another embodiment, the first to third operation cores 12, 13, and 14 may generate the first to third state information STATE<1:3> by accumulating the type and number of background operations performed in the respective first to third block groups as part of their operation state.

For example, when a set number or less of garbage collection operations are performed among a plurality of memory blocks in the first block group, the first operation core 12 may generate the first state information STATE1 having the value A. Furthermore, when more than the set number of garbage collection operations are performed among a plurality of memory blocks in the second block group, the second operation core 13 may generate the second state information STATE2 having the value B. Furthermore, when a bad memory block management operation is performed among a plurality of memory blocks in the third block group, the third operation core 14 may generate the third state information STATE3 having the value C, regardless of the number of bad memory block management operations.

For reference, in the examples, it is assumed that among the values of the first to third state information STATE<1:3>, the state of the block group corresponding to the value A is relatively better than the state of the block group corresponding to the value B, and the state of the block group corresponding to the value B is relatively better than the state of the block group corresponding to the value C.

Furthermore, the control core 11 may check the first to third state information STATE<1:3> at each set cycle and dynamically map the three third logical address ranges LBA3<0:99>, LBA3<100:199>, and LBA3<200:299> to the three first logical address ranges LBA1<0:99>, LBA1<100:199>, and LBA1<200:299>, respectively, as managed in the second mapping table 2^{ND} MAP_TB, based on the check results. That is, the control core 11 may determine the states of the first to third block groups based on the values of the first to third state information STATE<1:3> and dynamically adjust a mapping method between the three third logical address ranges LBA3<0:99>, LBA3<100:199>, and LBA3<200:299> and the three first logical address ranges LBA1<0:99>, LBA1<100:199>, and LBA1<200:299> based on the determination results.

As described above, the operation in which the control core 11 determines the states of the first to third block groups based on the first to third state information STATE<1:3> may serve as a method for ensuring that more important data is stored in the block group having a relatively better state from among the first to third block groups.

According to an embodiment, parity information PARITY may be included in the third-second write data 2^{ND} WDATA<3> from among the three second write data 2^{ND} WDATA<1:3>. That is, such a state may refer to a condition in which the parity information PARITY, generated by the error correction unit 138 (refer to FIG. 1B) through an error encoding operation on the first write data 1^{ST} WDATA, has been included in the third-second write data 2^{ND} WDATA<3> in the process of dividing the first write data 1^{ST} WDATA into the three second write data 2^{ND} WDATA<1:3>. In this case, considering that the error correction unit 138 can perform an error correction operation based on the parity information PARITY, the third-second write data 2^{ND} WDATA<3>, from among the three second write data 2^{ND} WDATA<1:3>, may be considered data having the highest importance.

Furthermore, the parity information PARITY may be included in the third-first read data 1^{ST} RDATA<3>, from among the three first read data 1^{ST} RDATA<1:3>, because the parity information PARITY is included in the third-second write data 2^{ND} WDATA<3>, from among the three second write data 2^{ND} WDATA<1:3>.

In this case, as described with reference to FIGS. 3A to 3C, if the control core 11 sequentially manages the three third logical address ranges LBA3<0:99>, LBA3<100:199>, and LBA3<200:299> and the three first logical address ranges LBA1<0:99>, LBA1<100:199>, and LBA1<200:299> in the second mapping table 2^{ND} MAP_TB, the third-second write data 2^{ND} WDATA<3>, from among the three second write data 2^{ND} WDATA<1:3>, may be accessed with respect to the third block group. That is, after the start of a write operation, the parity information PARITY may be written into the third block group along with the third-second write data 2^{ND} WDATA<3> from among the second write data 2^{ND} WDATA<1:3>. Likewise, even after the start of a read operation, the parity information PARITY may be in the state in which the parity information PARITY has been included in the third-first read data 1^{ST} RDATA<3> read from the third block group, from among the three first read data 1^{ST} RDATA<1:3>.

However, as exemplified in FIGS. 3B and 3C, when the first state information STATE1 has the value A, the second state information STATE2 has the value B, and the third state information STATE3 has the value C, the first block group may have a relatively better state than the second block group, and the second block group may have a relatively better state than the third block group. That is, as exemplified in FIG. 3A, if the control core 11 sequentially manages the three third logical address ranges LBA3<0:99>, LBA3<100:199>, and LBA3<200:299> and the three first logical address ranges LBA1<0:99>, LBA1<100:199>, and LBA1<200:299> in the second mapping table 2^{ND} MAP_TB, the parity information PARITY, which represents relatively important data, may be stored in the third block group, which has the worst state, among the first to third block groups.

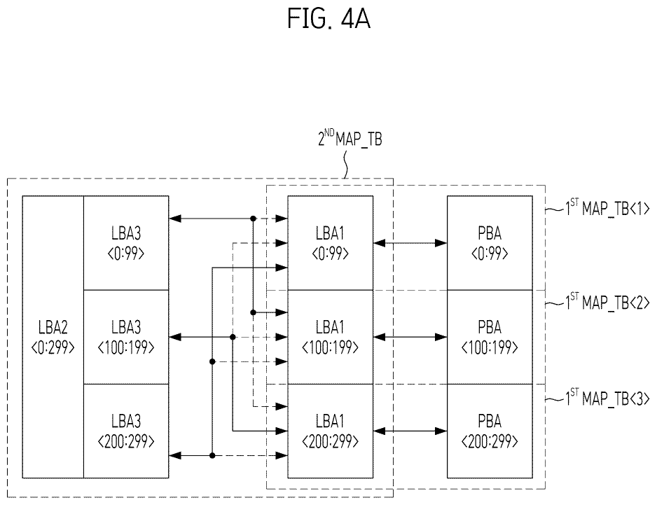

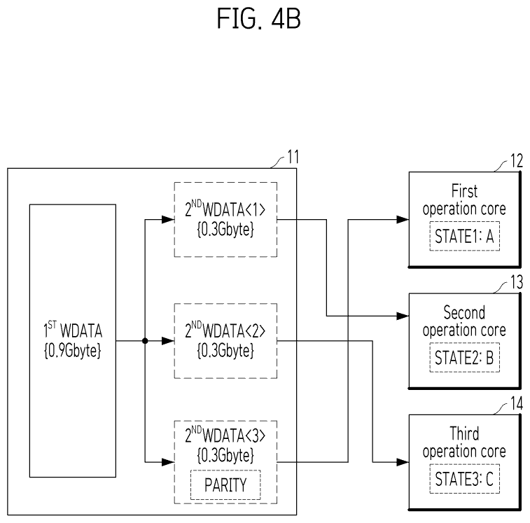

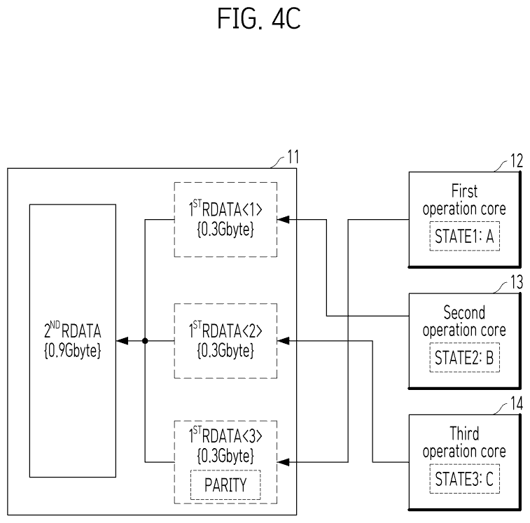

Accordingly, at the timing when a set cycle elapses after the first operation interval described with reference to FIGS. 3A to 3C, the control core 11 may check the first to third state information STATE<1:3> and dynamically adjust the sequence in which the three third logical address ranges LBA3<0:99>, LBA3<100:199>, and LBA3<200:299> and the three first logical address ranges LBA1<0:99>, LBA1<100:199>, and LBA1<200:299> are mapped, based on the check results in the subsequent second operation interval, as illustrated in FIGS. 4A to 4C.

FIGS. 4A to 4C illustrate an operation for controlling a plurality of storage spaces through a multi-stage mapping operation in the memory system according to another embodiment of the present disclosure.

Referring to FIG. 4A, it may be seen that the control core 11 adjusts the sequence in which the three third logical address ranges LBA3<0:99>, LBA3<100:199>, and LBA3<200:299> and the three first logical address ranges LBA1<0:99>, LBA1<100:199>, and LBA1<200:299> are mapped, in a manner different from the method described with reference to FIG. 3A.

Specifically, the control core 11 may sequentially divide the first 100 second logical address ranges, from among the total of 300 second logical address ranges LBA2<0:299> shared with the host 102 within the second mapping table 2^{ND} MAP_TB, into the Nos. 0 to 99 third logical address ranges LBA3<0:99>, divide the second 100 second logical address ranges into the Nos. 100 to 199 third logical address ranges LBA3<100:199>, and divide the third 100 second logical address ranges into the Nos. 200 to 299 third logical address ranges LBA3<200:299>.

In this state, the control core 11 may control an access operation for the second operation core 13 by managing a mapping operation between the Nos. 0 to 99 third logical address ranges LBA3<0:99> and the Nos. 100 to 199 first logical address ranges LBA1<100:199> within the second mapping table 2^{ND} MAP_TB. In this case, the second operation core 13 can control an access operation for the second block group using the second-first mapping table 1^{ST} MAP_TB<2>, from among three first mapping tables 1^{ST} MAP_TB<1:3>. Accordingly, the control of the access operation for the second operation core 13 by the control core 11 may mean that the access operation for the second block group is controlled.

Similarly, the control core 11 may control an access operation for the third operation core 14 by managing a mapping operation between the Nos. 100 to 199 third logical address ranges LBA3<100:199> and the Nos. 200 to 299 first logical address ranges LBA1<200:299> within the second mapping table 2^{ND} MAP_TB. In this case, the third operation core 14 can control an access operation for the third block group using the third-first mapping table 1^{ST} MAP_TB<3>, from among the three first mapping tables 1^{ST} MAP_TB<1:3>. Accordingly, the control of the access operation for the third operation core 14 by the control core 11 may mean that the access operation for the third block group is controlled.

Likewise, the control core 11 may control an access operation for the first operation core 12 by managing a mapping operation between the Nos. 200 to 299 third logical address ranges LBA3<200:299> and the Nos. 0 to 99 first logical address ranges LBA1<0:99> within the second mapping table 2^{ND} MAP_TB. In this case, the first operation core 12 can control an access operation for the first block group using the first-first mapping table 1^{ST} MAP_TB<1>, from among the three first mapping tables 1^{ST} MAP_TB<1:3>. Accordingly, the control of the access operation for the first operation core 12 by the control core 11 may mean that the access operation for the first block group is controlled.

Referring to the three first mapping tables 1^{ST} MAP_TB<1:3> and the second mapping table 2^{ND} MAP_TB described with reference to FIG. 4A, a write (or program) operation may be performed as illustrated in FIG. 4B.

Specifically, referring to FIGS. 4A and 4B, first write data 1^{ST} WDATA may be input from the host 102. In this case, it may be assumed that the size of the first write data 1^{ST} WDATA is 0.9 Gbyte.

The control core 11 may divide the second logical address ranges LBA2<0:299> corresponding to the first write data 1^{ST} WDATA into the three third logical address ranges LBA3<0:99>, LBA3<100:199>, and LBA3<200:299>, and thus divide the first write data 1^{ST} WDATA into three second write data 2^{ND} WDATA<1:3>. In this case, the size of each of the three second write data 2^{ND} WDATA<1:3> may be 0.3 Gbyte because the size of the first write data 1^{ST} WDATA is 0.9 Gbyte.

Furthermore, the control core 11 may transmit the three second write data 2^{ND} WDATA<1:3> to the second operation core 13, the third operation core 14, and the first operation core 12, respectively, based on the state in which the three third logical address ranges LBA3<0:99>, LBA3<100:199>, and LBA3<200:299>have been mapped to the three first logical address ranges LBA1<0:99>, LBA1<100:199>, and LBA1<200:299> in the sequence of the second-first logical address range LBA1<100:199>, the third-first logical address range LBA1<200:299>, and the first-first logical address rangeLBA1<0:99> within the second mapping table 2^{ND} MAP_TB.

Furthermore, the first to third operation cores 12, 13, and 14 may write the first-second write data 2^{ND} WDATA<1>, from among the three second write data 2^{ND} WDATA<1:3>, into the second block group, write the second-second write data 2^{ND} WDATA<2> into the third block group, and write the third-second write data 2^{ND} WDATA<3> into the first block group, based on the state in which the three first logical address ranges LBA1<0:99>, LBA1<100:199>, and LBA1<200:299> have been mapped to the three physical address ranges PBA<0:99>, PBA<100:199>, and PBA<200:299>, respectively, in the three first mapping tables 1^{ST} MAP_TB<1:3>, respectively.

More specifically, the control core 11 may transmit the first-second write data 2^{ND} WDATA<1>, from among the three second write data 2^{ND} WDATA<1:3>, to the second operation core 13. Accordingly, the second operation core 13 may write the first-second write data 2^{ND} WDATA<1>, from among the second write data 2^{ND} WDATA<1:3>, into the second block group.

Furthermore, the control core 11 may transmit the second-second write data 2^{ND} WDATA<2>, from among the three second write data 2^{ND} WDATA<1:3>, to the third operation core 14. Accordingly, the third operation core 14 may write the second-second write data 2^{ND} WDATA<2>, from among the second write data 2^{ND} WDATA<1:3>, into the third block group.

Furthermore, the control core 11 may transmit the third-second write data 2^{ND} WDATA<3>, from among the three second write data 2^{ND} WDATA<1:3>, to the first operation core 12. Accordingly, the first operation core 12 may write the third-second write data 2^{ND} WDATA<3>, from among the second write data 2^{ND} WDATA<1:3>, into the first block group.

Furthermore, referring to the three first mapping tables 1^{ST} MAP_TB<1:3> and the second mapping table 2^{ND} MAP_TB described with reference to FIG. 4A, a read operation may be performed as illustrated in FIG. 4C.

Specifically, referring to FIGS. 4A and 4C, the first to third operation cores 12, 13, and 14 may read three first read data 1^{ST} RDATA<1:3> from the first to third block groups, respectively, in the sequence of the third-first read data 1^{ST} RDATA<3>, the first-first read data 1^{ST} RDATA<1>, and the second-first read data 1^{ST} RDATA<2> based on the state in which the three first logical address ranges LBA1<0:99>, LBA1<100:199>, and LBA1<200:299> have been mapped to the three physical address ranges PBA<0:99>, PBA<100:199>, and PBA<200:299>, respectively, in the three first mapping tables 1^{ST} MAP_TB<1:3>, respectively. In this case, the size of each of the three first read data 1^{ST} RDATA<1:3> read in the sequence of the third-first read data 1^{ST} RDATA<3>, the first-first read data 1^{ST} RDATA<1>, and the second-first read data 1^{ST} RDATA<2> may be 0.3 Gbyte.

The control core 11 may output the three first read data 1^{ST} RDATA<1:3> read in the sequence of the third-first read data 1^{ST} RDATA<3>, the first-first read data 1^{ST} RDATA<1>, and the second-first read data 1^{ST} RDATA<2> as one second read data 2^{ND} RDATA based on the state where the three third logical address ranges LBA3<0:99>, LBA3<100:199>, and LBA3<200:299> have been mapped to the three first logical address ranges LBA1<0:99>, LBA1<100:199>, and LBA1<200:299> in the sequence of the second-first logical address range LBA1<100:199>, the third-first logical address range LBA1<200:299>, and the first-first logical address range LBA1<0:99> within the second mapping table 2^{ND} MAP_TB and where the three third logical address ranges LBA3<0:99>, LBA3<100:199>, and LBA3<200:299> are sequentially merged as one second logical address ranges LBA2<0:299>. In this case, the size of the second read data 2^{ND} RDATA may be 0.9 Gbyte, as the size of each of the three first read data 1^{ST} RDATA<1:3> read in the sequence of the third-first read data 1^{ST} RDATA<3>, the first-first read data 1^{ST} RDATA<1>, and the second-first read data 1^{ST} RDATA<2> is 0.3 Gbyte. That is, the control core 11 may output the second read data 2^{ND} RDATA having the size of 0.9 Gbyte to the host 102.

In other words, at the timing when a set cycle elapses after the first operation interval described with reference to FIGS. 3A to 3C, the control core 11 may check the first to third state information STATE<1:3> and control the parity information PARITY, which is relatively important data, to be stored in the first block group, which has the best state, among the first to third block groups. This may be achieved by mapping the three third logical address ranges LBA3<0:99>, LBA3<100:199>, and LBA3<200:299> to the three first logical address ranges LBA1<0:99>, LBA1<100:199>, and LBA1<200:299> in the sequence of the second-first logical address range LBA1<100:199>, and the third-first logical address range LBA1<200:299>, and the first-first logical address range LBA1<0:99> within the second mapping table 2^{ND} MAP_TB in the subsequent second operation interval, based on the check results, as illustrated in FIGS. 4A to 4C.

It will be evident to a person having ordinary knowledge in the art to which the present disclosure pertains that the present disclosure described above is not limited by the aforementioned embodiments and the accompanying drawings and that the present disclosure may be substituted, modified, and changed in various ways without departing from the technical spirit of the present disclosure.

What is claimed is:

1. A memory system comprising:
a memory device including a plurality of memory blocks; and
a controller configured to manage the plurality of memory blocks as N block groups,
wherein the controller comprises:
N operation cores, each configured to manage access to a corresponding block group by mapping a corresponding one of N physical address ranges corresponding to the N block groups to a corresponding one of N first logical address ranges; and
a control core configured to manage a second logical address range shared with a host by dividing the second logical address range into N third logical address ranges that are sequential, and to manage access to the N operation cores by dynamically mapping the N third logical address ranges to the N first logical address ranges,
wherein N is a natural number equal to or greater than 2.

2. The memory system of claim 1, wherein the controller further comprises:
N first mapping tables corresponding to the N operation cores, respectively, and
a second mapping table corresponding to the control core.

3. The memory system of claim 2, wherein each of the N operation cores manages a corresponding physical address range from among the N physical address ranges and a corresponding first logical address range from among the N first logical address ranges, in a corresponding first mapping table from among the N first mapping tables, by mapping the corresponding physical address range to the corresponding first logical address range.

4. The memory system of claim 3, wherein each of the N operation cores controls at least one of a background operation or a journaling operation within a corresponding block group from among the N block groups, with reference to a corresponding first mapping table from among the N first mapping tables.

5. The memory system of claim 4, wherein:
each of the N operation cores generates a corresponding piece of state information by accumulating an operation state of a corresponding block group from among the N block groups, and
the control core checks N pieces of state information at each set cycle and manages the N third logical address ranges and the N first logical address ranges in the second mapping table by dynamically mapping the N third logical address ranges to the N first logical address ranges based on results of the checking.

6. The memory system of claim 5, wherein each of the N operation cores generates the corresponding piece of state information by accumulating an error rate occurring after a start of an access operation for the corresponding block group as the operation state of the corresponding block group.

7. The memory system of claim 5, wherein each of the N operation cores generates the corresponding piece of state information by accumulating types and number of background operations performed in the corresponding block group as the operation state of the corresponding block group.

8. The memory system of claim 1, wherein the memory device further comprises:
a plurality of memory dies respectively corresponding to a plurality of channels through which data are input and output in an interleaving manner, each memory die comprising a plurality of planes,
wherein the plurality of planes respectively correspond to a plurality of ways through which data are input and output in an interleaving manner by sharing a channel, each plane including multiple memory blocks.

9. The memory system of claim 8, wherein the controller is configured to:
group, as a super-memory block, a memory block from a first plane of a memory die with a memory block from a second plane of the memory die; and
manage at least one super-memory block by including the at least one super-memory block in each of the N block groups.

10. The memory system of claim 8, wherein the controller is configured to:
group, as a super-memory block, a memory block from a first plane of a first memory die and a memory block from a first plane of a second memory die;
group, as a super-memory block, a memory block from a second plane of the first memory die and a memory block from a second plane of the second memory die; and
manage at least one super-memory block by including the at least one super-memory block in each of the N block groups.

11. The memory system of claim 8, wherein the controller is configured to:
group, as a super-memory block, a memory block from a first plane of a first memory die, a memory block from a second plane of the first memory die, a memory block from a first plane of a second memory die, and a memory block from a second plane of the second memory die; and
manage at least one super-memory block by including the at least one super-memory block in each of the N block groups.

12. An operating method of a memory system, the memory system comprising a memory device including a plurality of memory blocks and a controller configured to manage the plurality of memory blocks as N block groups, wherein the controller includes a control core corresponding to a host and N operation cores respectively corresponding to the N block groups, the operating method comprising:
managing, by each of the N operation cores, access to a corresponding one of the N block groups using a corresponding one of N first mapping tables that stores mappings between a corresponding one of N physical address ranges corresponding to the N block groups and a corresponding one of N first logical address ranges;
managing, by the control core, a second logical address range shared with a host by dividing the second logical address range into N third logical address ranges that are sequential;
managing, by the control core, access to each of the N operation cores using a second mapping table that stores mappings between the N third logical address ranges and the N first logical address ranges, wherein the mappings are dynamically updated,
wherein N is a natural number equal to or greater than 2.

13. The operating method of claim 12, further comprising controlling, by each of the N operation cores, at least one of a background operation or a journaling operation within a corresponding block group from among the N block groups, with reference to a corresponding first mapping table from among the N first mapping tables.

14. The operating method of claim 13, further comprising:
generating, by each of the N operation cores, a corresponding piece of state information by accumulating an operation state of the corresponding block group, and
checking N pieces of state information at each set cycle and managing the N third logical address ranges and the N first logical address ranges in the second mapping table by dynamically mapping the N third logical address ranges to the N first logical address ranges based on results of the checking, by the control core.

15. The operating method of claim 14, further comprising generating, by each of the N operation cores, the corresponding piece of state information by accumulating an error rate occurring after a start of an access operation for the corresponding block group as the operation state of the corresponding block group.

16. The operating method of claim 14, further comprising generating, by each of the N operation cores, the corresponding piece of state information by accumulating types and number of background operations performed in the corresponding block group as the operation state of the corresponding block group.

17. The operating method of claim 12, wherein the memory device further comprises:
a plurality of memory dies respectively corresponding to a plurality of channels through which data are input and output in an interleaving manner, each memory die comprising a plurality of planes,
wherein the plurality of planes respectively correspond to a plurality of ways through which data are input and output in an interleaving manner by sharing a channel, each plane including multiple memory blocks.

18. The operating method of claim 17, further comprising:
grouping, as a super-memory block, a memory block from a first plane of a memory die and a memory block from a second plane of the memory die; and
managing at least one super-memory block by including the at least one super-memory block in each of the N block groups.

19. The operating method of claim 17, further comprising:
grouping, as a super-memory block, a memory block from a first plane of a first memory die and a memory block from a first plane of a second memory die;
grouping, as a super-memory block, a memory block from a second plane of the first memory die and a memory block from a second plane of the second memory die; and
managing at least one super-memory block by including the at least one super-memory block in each of the N block groups.

20. The operating method of claim 17, further comprising:
grouping, as a super-memory block, a memory block from a first plane of a first memory die, a memory block from a second plane of the first memory die, a memory block from a first plane of a second memory die, and a memory block from a second plane of the second memory die; and
managing at least one super-memory block by including the at least one super-memory block in each of the N block groups.
